(19) United States
(12) Patent Application Publication
(10) Pub. No.: US 2009/0285106 A1
(43) Pub. Date: Nov. 19, 2009

(54) IPTV fault integration and fault location isolation

(75) Inventors: Marc R. Bernard, Miramar, FL (US); Guy M. Merritt, Purcellville, VA (US); Douglas A. Atkinson, Ashburn, VA (US); David Hwa-Wei Liu, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/152,797

(22) Filed: May 15, 2008

(51) Int. Cl. G06F 11/00

(52) U.S. Cl. 370/242

(57) ABSTRACT

A problem of collecting data unnecessarily in an Internet Protocol Television (IPTV) network is, in part, caused by a centralized approach to data collection, whereby data is collected for logical channels, even if not currently streaming to an end node. A method or corresponding apparatus of fault detection according to an example embodiment of the present invention provides for detecting and reporting faults specific to a logical IPTV channel in an IPTV network for logical channels actively streaming to an end user device, such as in response to a “join” request. One or more nodes supporting a logical IPTV channel provide fault indicators, which may be reported to another node or end user. Node(s) in the IPTV network may aggregate and process multiple fault indicators from across a network, thereby enabling diagnosis of specific errors in the IPTV network. Through the use of the method or apparatus, network resources are conserved.

### BACKGROUND OF THE INVENTION

Media service providers are increasingly providing content to consumers via a number of network-based means. Customer access points, such as a household network, often connect to a single external network providing multiple services via a common access line. For example, a customer may subscribe to television service, telephone service and Internet access, all of which is delivered through the network.

In traditional cable television (CATV) systems, several television channels are transmitted to a subscriber over a physical line, such as a coaxial cable, and each television channel is transmitted at a different carrier frequency over the physical line. Under digital CATV distribution, television channels are compressed and transmitted as logical channels, whereby each carrier frequency range may be occupied by a number of logical channels.

In contrast to traditional cable television, Internet Protocol Television (IPTV) delivers television channels via Internet Protocol (IP) across a packet-switched network. The service typically includes a number of television channels, and may also include audio channels, interactive content such as “Video on Demand” (VOD), and other media delivery. Media content sources (e.g., video servers, television and satellite broadcasts) are encoded to a digital, compressed format (e.g., MPEG format). When a subscriber to the IPTV service selects a particular channel to receive, the selected formatted content is transmitted, via a packet-based transport stream, across the IP network where it is received at a subscriber's networked device (e.g., a television set-top box or home computer). At the subscriber's networked device, the transport stream is decoded to display the selected television channel at the subscriber's television, mobile device, computer display or other device.

The packet-based transport stream carrying the media content may be considered a logical IPTV channel established across the network, and may be delivered to a single subscriber (“IP Unicast”) or broadcast to multiple subscribers (“IP Multicast”). To establish the logical IPTV channel, each node in the network along the path issues a “join” command to receive the selected IPTV channel.

### SUMMARY OF THE INVENTION

An example embodiment of the present invention enables fault detection of logical channels in a network. Characteristics of a logical channel are compared against a profile of criteria based on a request for the logical channel from a downstream node. In this manner, the integrity of the logical channel may be evaluated for one or more parameters as defined by the criteria. A fault indicator may be produced to indicate the results of this comparison, identifying for example a fault in the logical channel. The fault indicator may be reported, such as to an element management system (EMS), another node on the network, or a user or another entity for diagnosis or repair.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram representing a network in which embodiments of the present invention may be implemented.

FIG. 2 is a block diagram of a network path delivering content to a customer via a logical channel.

FIG. 3A is a block diagram of an Optical Network Terminal (ONT) in which an embodiment of the present invention may be implemented.

FIG. 3B is a block diagram of an Optical Network Terminal (ONT) in which an embodiment of the present invention may be implemented.

FIG. 4 is a flow diagram illustrating operation of a network device in an embodiment of the present invention.

FIG. 5 is a flow diagram of a process for configuring an Internet Protocol Television (IPTV) channel fault database.

FIG. 6 is a flow diagram illustrating processing multiple subnodes at a network device.

FIG. 7 is a flow diagram illustrating processing alerts at an Element Management System (EMS).

### DETAILED DESCRIPTION OF THE INVENTION

A description of example embodiments of the invention follows.

In typical Internet Protocol Television (IPTV) delivery networks, errors or faults in the network are reported as fault indicators (e.g., alarms) associated with an entire channel spectrum (i.e., a physical channel) in a manner similar to monitoring analog video services. These fault indicators have a number of drawbacks, requiring additional analysis of the network in order to determine the cause of the fault. Moreover, such fault indicators typically provide information regarding only limited aspects of a network, such as physical interfaces and amplifiers, and fail to indicate specific problems associated with data processing and network management. For purposes of this description the terms “entire channel spectrum” or “physical channel” refer to an entire downstream wavelength physical spectrum (e.g., 1490 nm (digital) or 1550 nm (analog)), and the terms “channel” or “subchannel” refer to any form of logical channel supported by a channel, where various forms of multiplexing or coding may be employed to define channels within a physical channel.

Embodiments of the present invention provide isolation of problems with specific IPTV channels, as opposed to detecting merely an error in the entire channel spectrum. Through techniques described below, a fault indicator, such as an alarm, may be declared when an IPTV-capable device detects that an IPTV channel does not meet pre-configured quality, latency or other performance parameters that are configured by the service provider. By aggregating and processing such fault indicators and associating multiple fault indicators regarding common IPTV channels, sub-domains of an IPTV network and specific nodes, fault indicators may be declared to determine the specific location and source of a network fault. As a result, specific faults within the network, including network congestion, hardware or software failure, or fiber integrity, can be detected, isolated and identified. In some embodiments, such faults may be detected at all nodes of an IPTV network supporting an IPTV channel between a video server (or other media source) and a video receiver (e.g., a set-top box), including faults at the video server and receiver. Embodiments of the invention can also minimize the number of faults reported for diagnosis, correlating several fault indicators that identify a common fault. Embodiments of the invention may be implemented in a network employing multicast or unicast media transport protocols that allow users to view specific channels, such as Internet Group Management Protocol (IGMP) (e.g., v2, v3), or Video on Demand (VoD) services.

Moreover, embodiments that apply fault detection to channels actually being delivered to an end user device, known by network nodes as a result of a “join” request or the like, resources (e.g., traffic processor bandwidth) applied to fault detection and diagnostics are conserved, allowing the resources to be used for other network functions. Thus, such embodiments can be viewed as end user directed fault detection, which is a distributed form of fault detection as compared to a centralized form of fault detection in which a supervisory node, such as an Element Management System (EMS) configures nodes to monitor for channel faults regardless of whether an end user device has actually joined a channel.

Further embodiments of the invention may implement a plurality of profiles of criteria corresponding to logical channels transmitted across a physical channel. A single profile may, for example, correspond to a plurality of logical channels, or may be specific to a single logical channel. The profiles of criteria can be configured to be directed to preferences of a channel provider, network service provider, or end user. The profile of criteria may indicate a threshold of average packet rate, burst rate, latency, jitter, bit error rate (BER), or other characteristics. Comparison between the logical channel and the profile of criteria may be initiated by a “join” request for the channel, and may be disabled in response to a “leave” request. A fault indicator, produced as a result of such a comparison, may be reported, for example, by transmitting the fault indicator to an upstream node or to a downstream node. An upstream node, upon receiving a fault indicator, may compare the logical channel against a profile of criteria, as well as correlate fault indicators produced by a plurality of nodes and report results of the correlating.

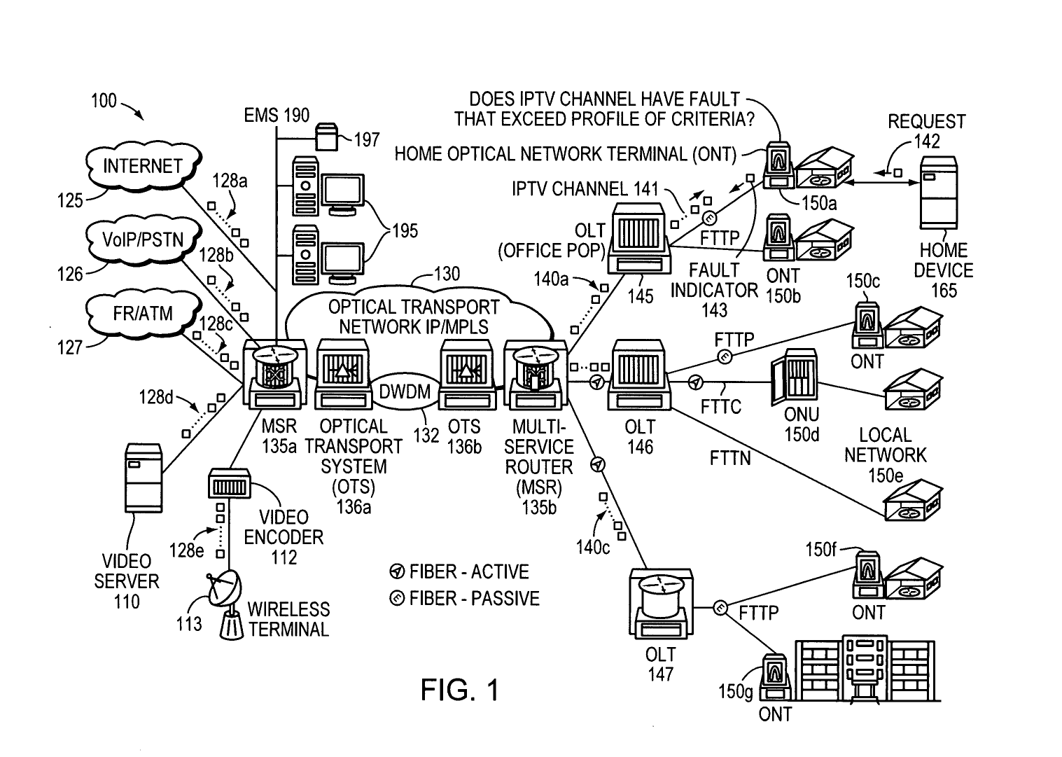

FIG. 1 is a diagram of an example network 100 structured for providing communications services to a number of customers. Service provider(s) (not shown) may configure an ingress multi-service router (MSR) 135 for communication with one or more external networks or data sources, such as the Internet 125, Voice Over Internet Protocol (VoIP) network 126, Frame Relay-Asynchronous Transfer Mode (FR-ATM) network 127, video server 110, or video encoder 112 providing a video stream based on communications at a wireless terminal 113. The MSR 135 routes communications to an Optical Transport System (OTS) 136a, which, in turn, converts the communications to optical signals (not shown) within an optical signaling protocol (e.g., IP Multi Protocol Label Switching (MPLS) or Dense Wavelength Division Multiplexing (DWDM)) for transport of the optical signals across an optical transport network 130 via optical fiber(s) 133 to a second OTS 136b.

An egress MSR 135b routes communications 140a-e, which may include data from any of the communications 128a-e received by the ingress MSR 135a to a plurality of Optical Line Terminals 145-147. From each OLT 145-147, communications may be routed to end users or subscribers 160 in a number of ways. For example, under a “Fiber to the Premises” (FTTP) configuration, a passive or active optical channel may connect the OLTs 145-147 to Optical Network Terminal(s) (ONT) 150a-c, 150f-g, which further route the communications 140a-c to a local network (not shown) and network devices (e.g., receiver 165) at the respective subscriber premises. Alternatively, a “Fiber to the Curb” (FTTC) configuration directs communications, via an active fiber channel, from an OLT 146 to an Optical Network Unit (ONU) 150d, providing network access to one or more subscribers local to the ONU 150d. Further, a “Fiber to the Node” configuration may terminate the optical channel at the OLT 146 or other node, providing network access to a subscriber's local network 150e via another medium (e.g., copper, Ethernet, coaxial cable, etc.).

In an example embodiment of the present invention, an ONT 150a receives an IPTV channel request 142 from a downstream home device (e.g., set-top box) 165. In response the ONT 150a joins (or attempts to join) the requested IPTV channel 141 to a downstream transmission to the home device 165. The ONT 150a evaluates whether the IPTV channel 141 meets a profile of criteria regarding performance or properties of the channel 141. If the IPTV channel 141 fails to meet this profile of criteria, or exhibits a fault that exceeds the profile of criteria, then the ONT 150a may report a fault indicator 143 to an upstream node, thereby enabling notification, diagnosis or repair of the IPTV channel 141.

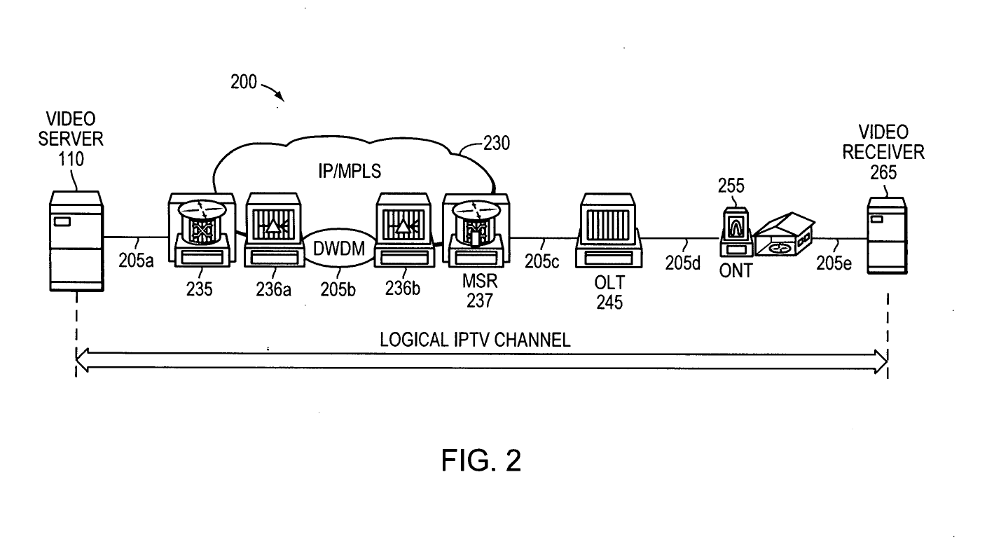

FIG. 2 is a block diagram illustrating a communications path 205a-e across nodes 210-265 of a network 200, which may be comparable to or different from the network 100 described above with reference to FIG. 1. Specifically, the network 200 communications path 205a-e supports logical IP Television (IPTV) channel(s) 290 through which an IPTV program (e.g., streaming audio/video or other media content) is delivered from a video server 210 to a video receiver 265 across the network 200. Transmission via the IPTV channel(s) 290 is routed from the video server 210 to an ingress MSR 235, first and second OTSs 236a-b across optical fibers 230, egress MSR 237, OLT 245, and an ONT 255 at the subscriber's premises, which, in turn, provides the IPTV channel 290 to the video receiver 265.

To establish the IPTV channel 290, the video receiver 265 may issue a request, either autonomously or controlled by a user, to receive the channel 290. This request may take the form of a “join” command, which is an instruction for the channel 290 to be joined with present downstream IP transmissions (e.g., other logical IPTV channels, Internet communications, Voice over IP (VoIP), etc.) to the video receiver 265. The join command may specify an IP address of the channel 260. The video receiver 265 transmits the join command to the ONT 255. If the ONT 255 is already receiving the channel 290 (e.g., for transmitting to other video receivers (not shown)), then it can immediately provide the channel 290 to the video receiver 265. To do so, the ONT 255 joins the channel 290 with downstream transmission, structuring the packet stream to the video receiver 265 to accommodate the logical IPTV channel 290. Conversely, if the ONT 255 is not receiving the channel 290 from an upstream node, then it transmits its own join command to the OLT 245 so that it can receive the channel 290 and, in turn, provide the channel 290 to the video receiver 265.

Upon receiving a join command from the ONT 255, the OLT 245 may respond in a manner similar to that described above with respect to the ONT 255. If the OLT is already receiving the channel 290 (e.g., for streaming to a different ONT (not shown)), then it may “join” the channel 290 with downstream transmission to the ONT 255, which, in turn, joins the channel 290 with downstream transmission to the video receiver 265. If the OLT 245 is not presently receiving the channel 290, it may transmit its own join command to the MSR 237. The above-described process of transmitting join commands to successive upstream nodes may continue until a node is located that is receiving the channel 290. The channel 290 is then joined at successive downstream nodes to establish the channel 290 at the video receiver 265.

In some applications, such as a video-on-demand service, the IPTV channel 290 may not exist at any node in the network 200 before it is requested by the user. In such a case, the video receiver 265 may issue a request to the video server 210 to create the channel 290 having the content requested by the user. Once created at the video server 210, the channel 290 is established at each downstream node 235, 237, 245, 255 to the video receiver 265.

In establishing or maintaining the logical IPTV channel 290, a number of factors may adversely affect the integrity of the channel 290. For example, one or more of the nodes of the network may lack the bandwidth or have too high a latency to deliver the channel 290, without error, to a downstream node. Congestion of packets in the network 200 may delay packets in the channel 290, causing distortion or disruption of the resulting television stream at the video receiver 265. Likewise, a physical line (e.g., optic fiber, coaxial cable, etc.) connecting any of the nodes may be compromised, resulting in packet loss or delay. Moreover, the factors described above may adversely affect an entire physical channel (i.e., all transmissions between two or more nodes), or may affect only the particular logical IPTV channel 290. For example, a node (e.g., OLT 245) may successfully deliver a number of logical IPTV channels (not shown) to several downstream ONTs, but may lack sufficient additional capacity to support the logical IPTV channel 290 with low latency and requisite bandwidth. As a result, the OLT 245 may reject a join command to support the channel 290, or may join the channel 290, resulting in the delivery of a sub-optimal channel to the video receiver 265 and/or the degradation of other transmissions supported by the OLT 245.

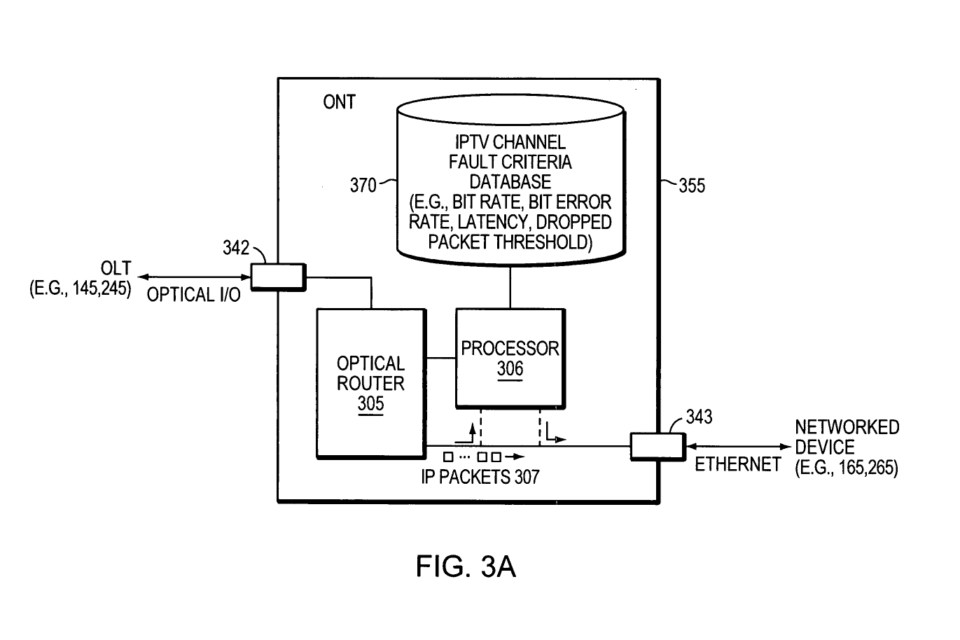

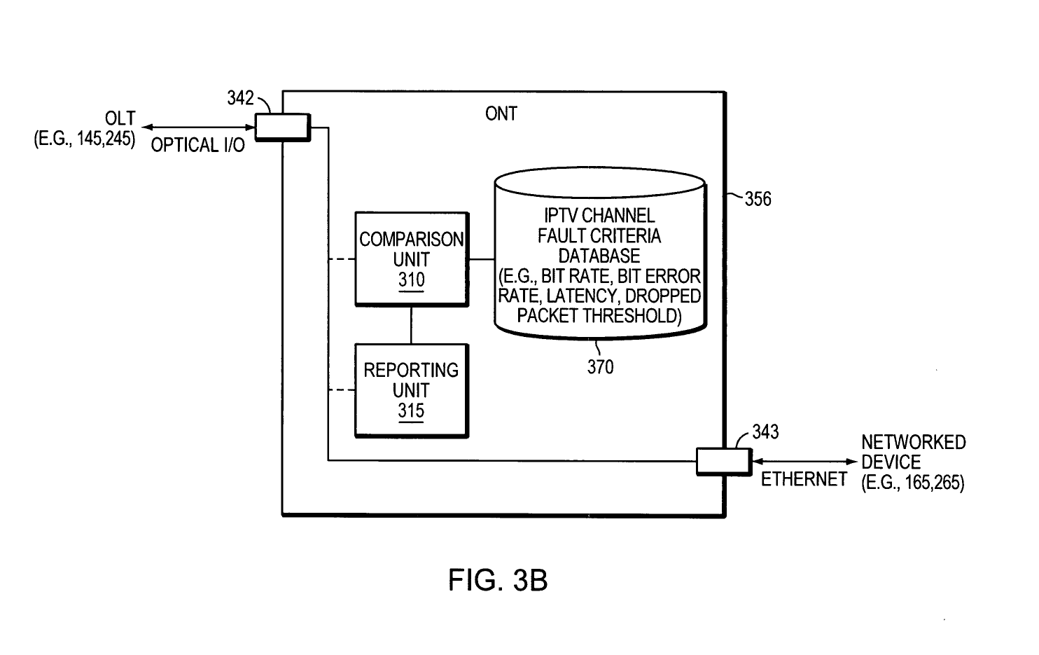

Some embodiments of the present invention operate to detect and isolate the location of faults affecting the integrity of a logical IPTV channel. With respect to the network 200, each of the nodes, including the video server 210, MSRs 235, 237, OLT 245, ONT 255 and video receiver 265, can be configured to detect a fault in upstream or downstream communications. This detection can include comparing the characteristics of a logical channel against a profile of criteria, and then reporting a fault indicator if the logical channel characteristics do not meet or exceed the criteria. By enabling such comparison and reporting among multiple nodes in the network, the location of a fault can be isolated, thereby aiding in diagnosis and repair of the network 200. The network nodes 210, 235, 236, 245, 255, 265 may be configured as described in further detail below with reference to FIGS. 3-9.

FIG. 3A is a general block diagram of an example Optical Network Terminal (ONT) 355 configured for detecting faults in a supported IPTV channel. The ONT 355 may be implemented as a node in a network, such as the networks 100, 200 described above with reference to FIGS. 1 and 2, for supporting an IPTV channel across the network. Likewise, the aforementioned network nodes (e.g., OLT 245, MSR 237, etc.) may be configured similar to the ONT 355 for fault detection and reporting.

The example ONT 355 receives optical communications from, and transmits optical communications to, an upstream node (e.g., OLT 145, 245) via an optical I/O port 342. An optical router 305 processes ingress optical communications (e.g., a logical IPTV channel), which may include converting payload data therein, to IP packet data. The optical router 305 forwards the IP packets 307 with the data to an Ethernet port 343, either directly or via a processor 306, for delivery to a networked device, such as a video receiver (e.g., receivers 165, 265). The processor 306, such as a central processing unit (CPU), on-board computer system, or application-specific integrated circuit (ASIC), may operate to monitor and control packet flow of both egress and ingress traffic. For example, the processor 306 may manage timing and priority of packet transmissions via a packet queue and may be configured to support one or more IPTV channels by structuring packet transmission to meet performance criteria of each channel. The processor 306 may also route communications via one or more additional Ethernet ports, coaxial cable ports, wireless ports or other ports (not shown) to additional downstream networked devices (e.g., a set-top box, computer or mobile device).

An IPTV Channel Fault Database (“fault database”) 370, implemented by a hard disk drive, Random Access Memory (RAM) or other storage medium, optionally volatile or nonvolatile memory, stores profiles of criteria relating to characteristics of logical IPTV channels. Each profile of criteria stored at the fault criteria database 370 may include a number of characteristics relating to threshold level(s) of performance of one or more logical IPTV channels. Such characteristics can include, for example, bit rate, bit error ratio (BER), latency and dropped packet threshold. Enforcing such criteria on a logical IPTV channel has a number of potential applications in an IPTV service. For example, a service provider may wish to ensure a minimal quality of transmission for all logical IPTV channels offered in the service. The service provider can also offer a tiered service with integrity thresholds that vary by logical IPTV channel or level of a customer's subscription. Further, a media content producer that provides a television channel may require that a respective logical IPTV channel is delivered to a subscriber with at least a certain level of quality. A subscriber may also request that some or all IPTV channels are received with minimal degradation. Embodiments of the present invention may be configured to address these and other applications by comparing a logical IPTV channel against a respective profile of criteria, indicating a fault if the channel does not meet a desired level of quality.

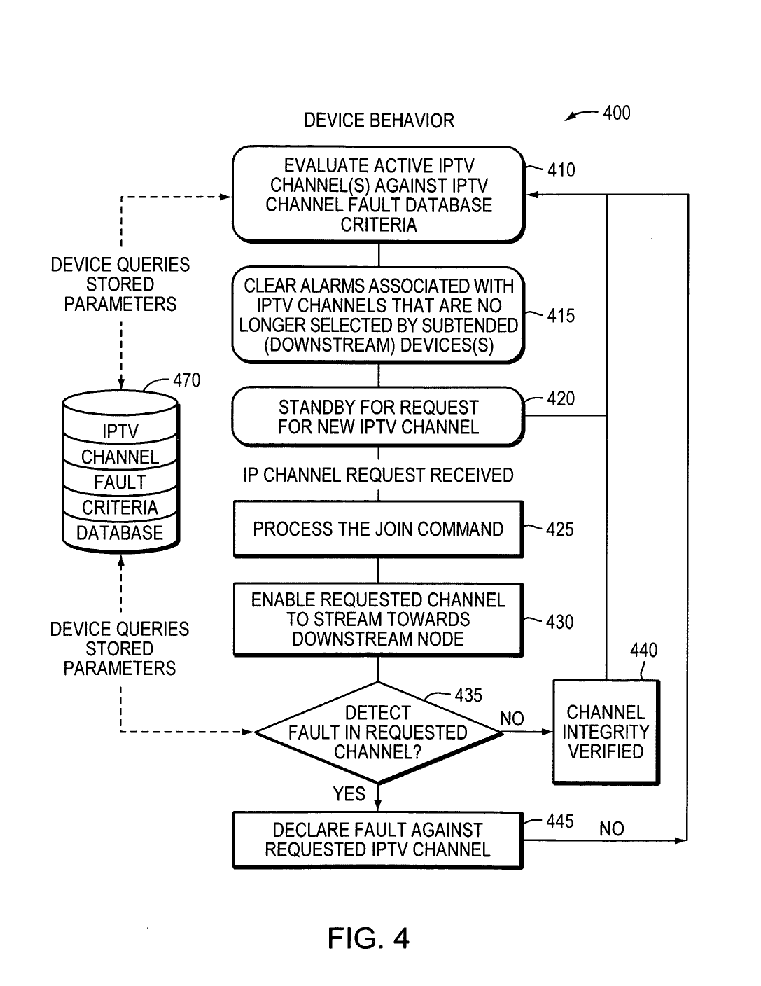

In this example embodiment, the processor 306 monitors an IPTV channel, to which a networked device has joined, for one or more such characteristics, and then compares those characteristics to those of a corresponding profile of criteria stored at the fault database 370. If the IPTV channel characteristics fail to meet or exceed the criteria, the processor 306 may indicate a fault in the IPTV channel. Example processes for configuring a fault database 370, detecting a fault and reporting the fault indicator are described in further detail below with reference to FIGS. 4-9.

FIG. 3B is a general block diagram of an example Optical Network Terminal (ONT) 356 configured for detecting faults in a supported IPTV channel. The ONT 356 may be implemented as a node in a network, such as the networks 100, 200 described above with reference to FIGS. 1 and 2, for supporting an IPTV channel across the network. Likewise, the aforementioned network nodes (e.g., OLT 245, MSR 237, etc.) may be configured similar to the ONT 356 for fault detection and reporting. The ONT 356 may also be configured to operate in a manner comparable to the ONT 355 described above with reference to FIG. 3A, or may incorporate components of the ONT 355.

The ONT includes a comparison unit 310, which compares characteristics of the logical channel received at the network optical I/O port 342 to a profile of criteria stored at the IPTV channel fault criteria database 370. As a result of this comparison, the comparison unit 310 may detect a fault in the logical channel. If a fault is detected, the comparison unit produces a fault indicator. The reporting unit 315 then reports the fault indicator to an upstream node. The comparison and reporting provided by the comparison unit and reporting unit, respectively, may incorporate features described above with respect to ONT 355 illustrated in FIG. 3, as well as the functions described below with respect to the flow charts in FIGS. 4-7.

FIG. 4 is a flow diagram illustrating a procedure 400 of operation of a network device in an example embodiment of the present invention. The network device may be operating as a node in an IPTV network, such as a video server, MSR, OLT or ONT described above with reference to FIGS. 1-3. A terminal network device receiving a logical IPTV channel, such as a set-top box or computer, may also operate as illustrated, with the exception that the terminal device does not support the channel towards a downstream node.

During typical operation, the device may be supporting one or more logical IPTV channels. Any logical IPTV channels that the device is presently supporting are considered “active” IPTV channels. The device evaluates one or more of the active IPTV channels by comparing characteristics of that channel against a corresponding profile of criteria at the IPTV channel fault criteria database 470 (410). In performing this evaluation, the device measures characteristics of the IPTV channel that correspond to those in the respective profile of criteria, such as bit rate, bit error ratio (BER), latency and dropped packet threshold. It then compares these characteristics to the profile of criteria at the fault database 470, indicating a fault (e.g., alarm) if the characteristics fail to meet or exceed the criteria. This evaluation of active channels (410) may occur continuously, periodically or in response to an external command to the device.

Likewise, the device also determines whether any active faults or alarms are associated with channels that are no longer active. Such faults or alarms may have been declared at an earlier time when a then-active channel was evaluated (410) and failed to meet its respective criteria. Following that evaluation, a downstream node may have deselected that channel, terminating the channel at the device, and making the associated fault or alarm irrelevant. Accordingly, the device may periodically or continuously detect when a fault or alarm is associated with an inactive channel and terminate that alarm (415). By doing so, the device avoids reporting unnecessary, intermittent, fault indicators resulting from only momentary selection of an IPTV channel. Alternatively, the device can be configured to maintain such faults or alarms after the channel becomes inactive, enabling the device to analyze the alarm or forward the alarm to another node (e.g., an EMS) to process further the alarm.

Following—or concurrently with—evaluating active IPTV channels (410) and clearing alarms (415), the device is receptive to requests for new IPTV channels (420). For example, a downstream set-top box may be controlled by a customer to select a new IPTV channel for viewing. The set-top box issues a “join” command specifying the selected channel to be established as an IPTV channel between a video server and the set-top box. The device receives and processes the “join” command by attempting to establish the IPTV channel at the respective node, as well as transmitting the “join” command to an upstream node, if necessary (425). In doing so, the device allocates network bandwidth for the IPTV channel in accordance with packet throughput and timing as required to carry the channel, thereby enabling the requested IPTV channel to stream from an upstream node toward the downstream node (430).

Upon streaming the IPTV channel, the device evaluates the channel in order to detect whether a fault is present in the channel (435). In so doing, the device queries the IPTV channel fault database 470, which may be located at the device or at another node of the network. The query returns a profile of criteria, or stored parameters, relating to the performance of the requested IPTV channel. This profile of criteria may be specific to the requested IPTV channel, or may be applicable to multiple channels as specified by the service provider or in response to a customer request for a threshold quality of service. The device then measures qualities of the requested IPTV channel as it is streamed at the node, such as for bit rate, bit error ratio (BER), latency and number of dropped packets, and compares those qualities to respective criteria of the retrieved profile of criteria.

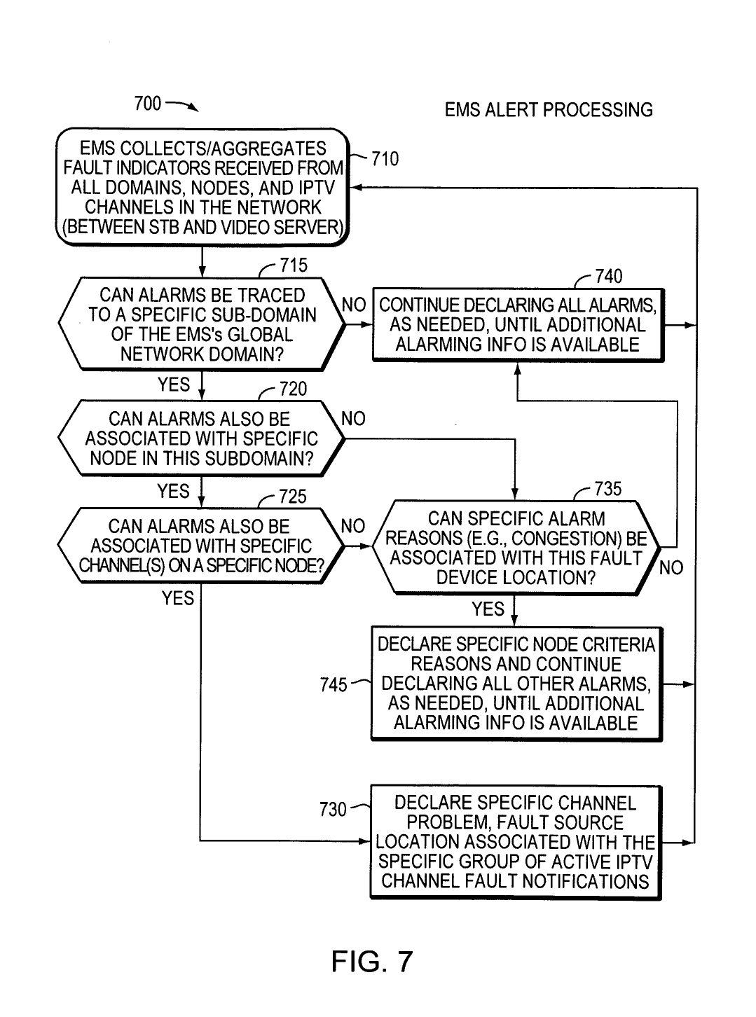

If the requested IPTV channel meets all criteria of the profile of criteria, then the integrity of the channel is verified (440). This verification can terminate further evaluation of the channel until continued evaluation of active IPTV channels (410). Alternatively, the device may transmit a “verification” signal to upstream nodes in order to aid an EMS in diagnosing fault in the network. Conversely, if a fault is detected, where one or more characteristics of the requested IPTV channel fail to meet the profile of criteria, then the device declares a fault against the requested IPTV channel (445). An alarm, or fault indicator corresponding to the fault, may be reported to an upstream node (such as an EMS) for further diagnosis, as described in further detail below with reference to FIG. 7. The fault indicator may also be reported to a downstream node, such as a set-top box, where the fault may be reported to a customer as an error message displayed on a television or other medium.

A detected fault need not result in terminating the IPTV channel; rather, the channel may be maintained depending on configuration of the profile of criteria or the customer's option. For example, particular faults may result in terminating the requested IPTV channel, while others may cause an error message to be conveyed to a customer, where the customer has the option of continuing the IPTV channel despite the fault. Such options may be configured as components of the profile of criteria for a specific channel or a group of channels.

With reference to FIG. 1, for example, first and second ONTs 150a, 150b receive IPTV channels from an OLT 145, where each OLT and ONT evaluates channels as illustrated in FIG. 4. If the first ONT 150a fails to stream a requested IPTV channel meeting respective criteria, it reports a fault indicator to the OLT 145, which may forward the fault indicator to the EMS 190. The EMS 190 is a computer system or network, which may include one or more servers 195 and a data storage device 197 that are communicatively coupled to the network 100. The EMS 190 may be configured to collect and process reported fault indicators and other communications data to monitor the performance of the network 100. The EMS 190 may also be configured to control operation or network traffic at one or more nodes in the network 100, enabling a network administrator to repair faults in the network 100. If the source of the failure is at—or upstream of—the OLT 145, the OLT 145 may detect and report the same or similar fault indicator. Yet if the fault is caused by failure at the ONT 150a or its connecting fiber, the OLT 145 may also detect a fault, despite the source of the fault being remote to it. Here, the second ONT 150b can aid in locating the source of the fault by reporting a “verification” signal upon successfully establishing the same IPTV channel without fault. Such a “verification” signal indicates that the OLT 145 can support the requested IPTV channel without fault, and that the fault is specific to the first ONT 150a. In some embodiments of the present invention, fault detection may not detect a fault originating from a downstream node, thereby confining diagnosis to fewer nodes.

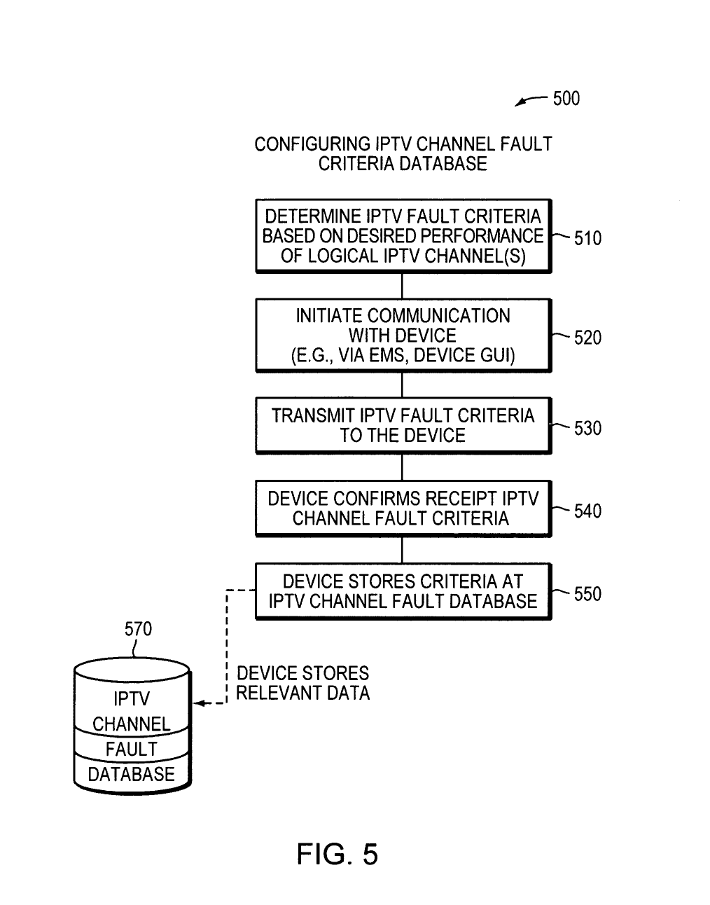

FIG. 5 is a flow diagram of a process 500 for configuring an IPTV channel fault database 570. As described above, the IPTV channel fault database 570 may reside at one or more networked home devices, OLTs, ONTs, MSRs or other nodes of an IPTV network. Multiple nodes may access a common database 570 via communications across the network. To configure the database 570, a threshold level of performance for a particular IPTV channel (or group of channels) is determined as a level to be enforced against transmission of that IPTV channel. A number of preferences, such as of a service provider, media content producer, and/or a customer, may affect this threshold level of performance. For example, a service provider may decide to guarantee a minimum level of quality for all or some of the IPTV channels offered in a service. Level of quality may be tiered among the channel spectrum, with certain tiers of channels requiring higher levels of quality in transmission. The service provider may offer a tiered subscription service, where a customer pays a higher rate to receive IPTV channels at a higher quality, or a lower rate to receive channels at lesser quality. Further, a media content producer may prefer that an IPTV channel carrying its content have a high quality of transmission. Further still, a customer may decide to receive an IPTV channel conditional on the channel meeting a certain level of quality, or may wish to receive a channel despite apparent errors in the transmission. Some or all of the above concerns may determine a level of performance to be enforced against an established IPTV channel.

Based on the desired level of performance, a profile of IPTV fault criteria is determined (510). This criteria is quantified such that a transmitted IPTV channel meeting this criteria will meet the desired level of performance. For example, a level of performance may correspond with a minimum BER, bit transmission rate, or ratio of dropped packets, which, in turn, may be incorporated into the profile of criteria. A determination of fault criteria may be made by the service provider, either manually or automatically at an EMS receiving performance requests from a service provider and/or customer. Profiles of criteria may be determined on a per-channel, per-class (of channels), per-customer or per-program (i.e., specific transmission on an IPTV channel) basis.

To implement the determined IPTV fault criteria, communication is initiated with the device on which the IPTV channel fault database resides (520). Such communication may be initiated via an EMS or another node, or at a user interface (e.g., GUI) at the device. When multiple IPTV channel fault databases are implemented (e.g., each node maintains a local copy of fault criteria), devices corresponding to each of the databases may be contacted by such means in parallel, thereby enabling all databases to be configured simultaneously. Once communication is established, the IPTV fault criteria is transmitted to the device (530), and the device confirms successful receipt of the criteria (540). The device then accesses the IPTV channel fault database 570, configuring the database 570 to incorporate the received criteria (550). If the received criteria is inconsistent with criteria already stored at the device, then the device may update the existing criteria with the newly received criteria. As a result, the IPTV channel fault database 570 is configured with one or more profiles of criteria for reference by one or more devices for evaluating respective IPTV channels.

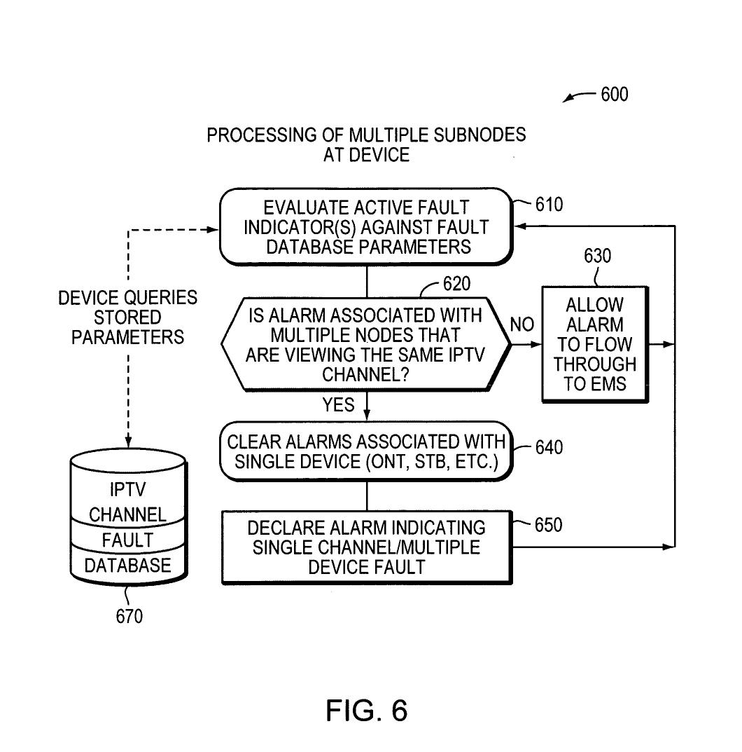

FIG. 6 is a flow diagram illustrating processing indicators originating from multiple subnodes at a network device. This process 600 may be completed by a device at an EMS or other node receiving fault indicators from multiple nodes of an IPTV network. For example, an MSR (e.g., MSR 137 in FIG. 1) or OLT may receive fault indicators reported at multiple downstream nodes, process those fault indicators (600) to provide integrated fault indicators where applicable, and forward the results of processing to an EMS for diagnosis of the IPTV network. In some embodiments, all fault indicators reported by ONTs, OLTs and other nodes in the IPTV network are forwarded to a common device performing this process 600. The process 600 is completed for each fault indicator received.

Upon receiving fault indicators from such nodes, the device evaluates those fault indicators by comparing them against a corresponding profile of criteria retrieved from an IPTV channel fault database 670 (610). Although the fault indicator was reported as a result of the same or similar evaluation at another node, this further evaluation may aid in processing of multiple subnodes as illustrated. For example, the evaluation (610) may serve as an error check to the reported fault indicator. Further, the IPTV channel fault database 670 may be configured with profiles of criteria that are distinct from the profiles of criteria (residing at another fault database) referenced in reporting the fault indicator. Such a disparity in profiles of criteria may be implemented to filter certain fault indicators from being forwarded to an EMS for diagnosis, or may be the result of a customer-specific configuration as described above with reference to FIG. 5.

Following evaluation, the device inquires as to whether the fault indicator is one of multiple fault indicators associated with the same IPTV channel and reported by different nodes (620). The fault indicator may be “held” for a given length of time during this inquiry, thereby allowing other fault indicators relating to the same fault to be received at the device. Alternatively, the fault indicator may be forwarded immediately to an EMS (630) while a record of the fault indicator is maintained for processing of fault indicators received at a later time.

If the fault indicator is not associated with other fault indicators concerning a common IPTV channel, then the device may forward the alarm to the EMS for further processing and diagnosis (630). However, if the fault indicator is one of multiple alarms associated with a particular IPTV channel, then the device clears all such indicators, which may be each associated with a different node (e.g., one or more ONTs, OLTs and MSRs) (640). The cleared fault indicators are replaced by declaring a new fault indicator, a “single channel/multiple device” alarm (or “multi-fault indicator”) which effectively aggregates the cleared fault indicators (650). The multi-fault indicator may include some or all of the data regarding the fault indicators on which it is based, such as the specified IPTV channel, the identity and location of each of the nodes reporting the fault, and characteristics (e.g., channel transmission data) of the fault. The multi-fault indicator may be forwarded to the EMS for further processing and diagnosis.

FIG. 7 is a flow diagram illustrating processing alerts at an EMS. This process 700 may be implemented by an EMS (e.g., EMS 190 in FIG. 1) or other node receiving reported fault indicators and/or multi-fault indicators. The EMS initializes processing of fault indicators by collecting and aggregating all fault indicators received from all domains and nodes in the IPTV network and concerning all IPTV channels (710). In doing so, the EMS may create or maintain a unified database including all fault indicators that may be indexed and queried. The EMS then performs a series of inquiries (715, 720, 725, 735) concerning the fault indicators to diagnose the network and determine the source of the fault(s). The inquiries may be performed on all received fault indicators or a particular group of fault indicators, and may be repeated for successive fault indicators.

The EMS may also initiate this process 700 in response to a periodic or triggered inquiry of network or node status. For example, it could process received fault indicators in response to a periodic timer, intervention by a user (i.e., craft person or network administrator), or upon receiving a particular type of alarm or fault indicator. The EMS could be configured, for example, to respond immediately to more significant alarms (e.g., extensive failure reported at an MSR) by initiating the process 700 to diagnose such alarms. In further embodiments of the invention, the EMS may respond to such a trigger by communicating with some or all nodes in the IPTV network to receive present fault indicators. Thus, the EMS need not wait to receive new or updated fault indicators from the network, and may initiate processing of fault indicators while ensuring the received status indicators are accurate.

The EMS first determines whether the fault indicators can be traced to a specific sub-domain of the IPTV network, such as a series of nodes connected to support a common IPTV channel (715). If a trace cannot be made, the EMS continues declaring all received fault indicators until further fault information (e.g., additional fault indicators) are available (740). If the EMS can trace the fault indicators to a specific sub-domain, then the EMS further determines whether the fault indicators can be associated with a specific node within the subdomain (720). If so, it is also determined whether the fault indicators can be associated with a specific IPTV channel (725). If the fault indicators are associated with a specific node and IPTV channel, then the EMS declares a problem with the associated IPTV channel and declares a fault specifying the location of the associated node (730). Thus, the EMS identifies a source common to multiple fault indicators. In response, the EMS (or a craft person operating the EMS) may retrieve further information about the fault source, such as the network performance of the associate node, and initiate actions to repair the fault.

If the fault indicators cannot be associated with a common node or IPTV channel, then the EMS further inquires as to whether specific causes (e.g., network congestion) can be associated with the associated network sub-domain (735). If so, the EMS may report those causes for further processing and repair, and maintain some or all of the fault indicators until additional fault information is available (745).

It should be understood that the block diagram of FIG. 3 and the flow diagrams of FIGS. 4-7 are examples that can include more or fewer components, be partitioned into subunits, or be implemented in different combinations. Moreover, the flow diagrams may be implemented in hardware, firmware, or software. If implemented in software, the software may be written in any software language suitable for use in networks as illustrated in FIGS. 1-2. The software may be embodied on any form of computer readable medium, such as RAM, ROM, or magnetic or optical disk, and loaded and executed by generic or custom processor(s).

While this invention has been particularly shown and described with references to example embodiments thereof, it will be understood by those skilled in the art that various changes in form and details may be made therein without departing from the scope of the invention encompassed by the appended claims.

For example, although described with respect to IPTV, it should be understood that the principles of the present invention apply to networking in which distributed fault detection enabling and disabling apply. Example may include multicasting, push content, or pull content in which a source or destination node identifies the channel or flow to be active between source or destination nodes. Thus, either source or destination party may cause fault detection to enable.

What is claimed is:

1. A method of detecting a fault in a network, comprising:
enabling a comparison of characteristics of a logical channel against a profile of criteria based on a request for the logical channel from a downstream node;
performing the comparison to produce a fault indicator; and
reporting the fault indicator.

2. The method of claim 1 wherein the profile is one of a plurality of profiles of criteria corresponding to logical channels transmitted across a physical channel.

3. The method of claim 2 wherein the profile includes criteria based on at least one preference of a channel provider or end user.

4. The method of claim 2 wherein the profile is one of a plurality of profiles of criteria corresponding to the logical channel.

5. The method of claim 2, wherein the profile corresponds to a plurality of logical channels configured for transmission across the network.

6. The method of claim 1 wherein the profile of criteria indicates a threshold of at least one of the following: average packet rate, burst rate, latency, jitter, or bit error rate (BER).

7. The method of claim 1 wherein enabling the comparison occurs in response to a ‘join’ request for receipt of the logical channel.

8. The method of claim 7 further comprising disabling the comparison based on a ‘leave’ request.

9. The method of claim 1 wherein reporting the fault indicator includes transmitting the fault indicator to an upstream node.

10. The method of claim 9 further comprising:
comparing, at the upstream node, characteristics of the logical channel against the profile of criteria;
correlating fault indicators produced by nodes comparing the characteristics of the logical channel against the profile of criteria; and
reporting results of the correlating.

11. The method of claim 1 wherein reporting the fault indicator includes transmitting the fault indicator to the downstream node.

12. An apparatus for detecting fault in a network, comprising:
a network port coupled to a network and configured to enable a logical channel between an upstream node and a downstream node in response to a request for the logical channel from the downstream node; and
logic to compare characteristics of the logical channel against a profile of criteria to produce a fault indicator; and
a reporting unit to report the fault indicator.

13. The apparatus of claim 12, wherein the profile is one of a plurality of profiles of criteria corresponding to logical channels transmitted across a physical channel.

14. The apparatus of claim 12, wherein the profile includes criteria based on preferences of one or more of a channel provider and end user.

15. The apparatus of claim 12, wherein the profile corresponds to a plurality of logical channels configured for transmission across the network.

16. The apparatus of claim 12, wherein the profile of criteria indicates a threshold of at least one of the following criteria: average packet rate, burst rate, latency, jitter and bit error rate (BER).

17. The apparatus of claim 12, wherein the request for receipt of the logical channel includes a join request.

18. The apparatus of claim 17, wherein the logic is further configured to disable the comparison based on a leave request.

19. The apparatus of claim 12, wherein the reporting unit is configured to report the fault indicator to an upstream node.

20. The apparatus of claim 12, wherein the reporting unit is configured to report the fault indicator to a downstream node.

21. A computer readable medium having computer readable program codes embodied therein for detecting a fault in a network, the computer readable medium program codes including instructions that, when executed by a processor, cause the processor to:
enable a comparison of characteristics of a logical channel against a profile of criteria based on a request for the logical channel from a downstream node;
perform the comparison to produce a fault indicator; and
report the fault indicator.
